(19) United States
(12) Patent Application Publication
(10) Pub. No.: US 2026/0041067 A1
(43) Pub. Date: Feb. 12, 2026

(54) MANURE CONVEYING DEVICE, IN PARTICULAR FOR USE IN BARN EGG PRODUCTION OR BROILER PRODUCTION

(71) Applicant: noltewerk GmbH & Co. KG, Greven (DE)

(72) Inventor: Christoph VAN ÜÜM, Gescher (DE)

(21) Appl. No.: 19/293,672

(22) Filed: Aug. 7, 2025

(30) Foreign Application Priority Data
Aug. 8, 2024 (DE) 10 2024 122 657.9
Aug. 5, 2025 (EP) 25194081.3

(51) Int. Cl. A01K 31/04; A01K 31/00

(52) U.S. Cl. CPC A01K 31/04; A01K 31/005

(57) ABSTRACT

A manure conveyor device includes a conveyor including a conveyor belt to receive manure and at least one driver to move the conveyor. One end of the conveyor is fixedly connected to a rotatably drivable drive drum. The manure conveyor device is configured to remove manure located on an upper side of the conveyor belt when the conveyor is wound onto the drive drum.

### CROSS REFERENCE TO RELATED APPLICATIONS

This application claims the benefit of priority to German Patent Application No. 10 2024 122 657.9 filed on Aug. 8, 2024 and European Patent Application No. 25194081.3 filed on Aug. 5, 2025. The entire contents of these applications are hereby incorporated herein by reference.

### BACKGROUND OF THE INVENTION

### 1. Field of the Invention

The present invention relates to manure conveying devices, methods of using manure conveying devices in animal husbandry, in particular, for use in barn egg production or for broiler production, and methods for conveying manure.

### 2. Description of the Related Art

It is known to use manure conveying devices for the fully mechanical removal of manure from laying hens from the barn.

The utility model DE 20 2008 012 721 U discloses a manure conveyor belt located below the floor area accessible to the animals. The floor area is made of a manure-permeable grid and the manure falls through the grid onto the conveyor belt. The conveyor belt runs between the cages arranged in floors. The manure is regularly removed and transported via cross conveyor belts at the end of the barn to central storage halls, where it is then temporarily stored. The conveyor belt is designed to run around continuously.

In indoor housing systems for laying hens, the floor area is set up as a scratching area and the laying hens are provided with aviaries with laying nests between the parallel barn aisles, which can be attached to perches and/or platforms arranged one above the other or offset. The laying hens can walk and scratch in the barn aisles and under the aviaries. In the scratching area, also known as the usable floor space, there is litter on the floor on which the animals can run around and scratch. The barn aisle is used to cross the barn and is used by the animals and, if necessary, by personnel.

### SUMMARY OF THE INVENTION

Example embodiments of the present invention provide manure conveyor devices to support removal of manure from floor areas.

A manure conveying device according to an example embodiment of the present invention includes a conveyor including a conveyor belt to receive manure, and at least one driver to move the conveyor, wherein a first end of the conveyor is fixedly connected to a first rotatably drivable drive drum, the manure conveyor device is configured to remove manure located on the conveyor belt when the conveyor is wound onto the first rotatably drivable drive drum.

The manure conveyor device according to this example embodiment of the present invention allows a barn to be laid out lengthwise with the conveyor belt, manure to be collected on the conveyor belt over a large area, and, if necessary, the manure to be removed by winding up the conveyor.

The conveyor belt defines a conveying surface to convey the manure.

The conveyor belt preferably has a constant width and has a full-surface design.

The conveyor belt is preferably made at least partly of plastic, especially PVC, as this makes it easy to remove manure. Alternatively, PU, silicone, PE, or rubber can also be used. The conveyor belt preferably includes at least one fabric layer to increase stability. Preferably, the transport side is made of plastic. The running side can be coated with plastic to reduce noise. However, it is also conceivable to arrange the fabric layer on the running side, as this is advantageous in damp conditions because no adhesion occurs. The conveyor belt can also be made of polyamide fabric.

The conveyor belt preferably may have a length (preferably continuous) of about 50 m to about 310 m, in particular about 80 m to about 150 m, and/or a width of about 0.5 m to about 30 m, in particular about 0.5 m to about 2 m or about 10 m to about 30 m, for example. The conveyor belt covers a large area of the floor space of the barn when fully laid out.

In one example embodiment of the present invention, a second end of the conveyor is fixedly connected to a second rotatably drivable drive drum that can be rotated, wherein the manure conveyor further includes a return device around which the conveyor is reversed and returns. It is advantageous if there is a single driver to selectively drive the first rotatably drivable drive drum or the second rotatably drivable drive drum.

Furthermore, the manure conveyor device may include a scraper to scrape off manure located on the upper side of the conveyor belt when the conveyor belt is wound onto the drive drum by the driver.

The scraper preferably includes a V-shaped (and mirror-symmetrical) scraper strip arranged so that it tapers towards the opposite side of the winding direction. This makes it particularly easy to scrape off the manure. The scraper strip preferably forms an angle greater than about 90°, for example.

In an advantageous example embodiment of the present invention, at least one end of the conveyor belt is connected to a pulling device connected to a drive drum. The pulling device can be a belt, rope, toothed belt, chain or the like. The pulling device is preferably attached to one end of the conveyor belt by a clamping strip. It is advantageous if the conveyor belt and the pulling device are dimensioned such that the conveyor belt covers a large area of the floor when fully extended and only the pulling device is located on the drive drum at all times. In other words, when fully extended, the conveyor belt lies flat (in a single layer) in the barn. This saves material and weight and reduces costs.

In an example embodiment of the present invention, there are two drive drums located in close proximity to each other, with a distance to the return device being between about 50 m and about 310 m, for example. Preferably, a pulling device is attached to both ends of the conveyor belt, and the conveyor belt is wound and unwound in opposite directions on one of the drive drums. The length of the pulling device and the conveyor belt are preferably dimensioned such that the conveyor belt always runs back and forth between the drive drums via the return device and is not wound up or unwound. When fully extended, the conveyor belt lies on the floor between a drive drum and the return device. A pulling device may be located below the conveyor belt. However, it is also conceivable to locate the pulling device at a distance to the side of the conveyor belt. For mucking out, the pulling device may be wound up or unwound so that the conveyor belt runs over the return device, such that the manure on the transport side falls down and the conveyor belt runs back on the rear side. When completely cleaned, the pulling device is located on the now upward-facing running side and the conveyor belt is upside down on the floor. This state can be used to pick up manure again.

It is particularly advantageous if the pulling device has a width of less than about 50% of the conveyor belt width, in particular less than about 30% and/or less than about 300 mm, for example.

When selecting the pulling device, it should be ensured that it has the required tensile strength. In particular, the tensile strength of the pulling device should be substantially the same as that of the conveyor belt.

In one example embodiment, a second driver and a second drive drum rotatably driven by the second driver are included, wherein the second end of the conveyor belt is fixedly connected to the second drive drum. The conveyor belt can thus be wound and unwound back and forth between the two drive drums. The second drive drum can be housed in the housing of the first drive drum and the conveyor belt can be reversed in direction and returned by a return device (at the other end of the barn aisle). The conveyor belt can then be automatically pulled out and rolled up. The distance between the two drive drums is preferably in the range between about 300 mm and about 1200 mm, for example. It is conceivable that the second end of the conveyor belt is attached to the second drive drum or to at least one pulling device which is firmly connected to the second drive drum. However, it is also conceivable to house the second drive drum in its own housing and place it at the other end of the manure removal section or the barn. The distance between the two drive drums is then preferably in a range between about 50 m and about 150 m, for example. The two drive drums are preferably placed at one end of a barn aisle each.

In another example embodiment, the second end of the conveyor belt is free. The conveyor belt is rolled out and laid out in the barn manually or with a separate pulling device.

Furthermore, it is intended to previously described manure conveyor device to at least partially cover a (concrete) floor area for animal husbandry, in particular for barn egg production or broiler production, with the conveyor belt and to remove manure from the floor area.

When laid out, the upper side of the conveyor belt provides a standing area for the animals and can therefore be regarded as usable barn floor space. The laid-out state is maintained for at least about 80%, in particular about 90%, for example, of the weekly period. During manure removal, there can be a substantially constant discharge of manure over the entire length of the conveyor belt, which is particularly advantageous for planning the removal.

In addition, a barn for barn egg production is provided with parallel barn aisles and aviaries arranged between them (raised on stilts), such that the floor area provides a scratching area for the laying hens and at least one manure conveyor device as described above is used. The conveyor belt is preferably laid parallel or substantially parallel to the barn aisles and is located in the barn aisles and/or below the aviaries. The length of the conveyor belt preferably corresponds to the length of the usable barn floor space, in particular at least about 90% of the length of the usable barn floor space, for example.

Preferably, the barn has a cross conveyor belt running transverse to the barn aisles, and the manure conveyor device is configured to remove manure from the conveyor belt to the transport side of the cross conveyor belt during mucking out.

The removal can be carried out with a scraper in front of the drive or with an existing return device, where the manure simply falls down and, optionally, a scraper cleans the conveyor belt.

The cross conveyor belt preferably also picks up the manure from the manure conveyor devices arranged in the aviaries and running below the grids used there.

The cross conveyor belt can be arranged in a pit.

The cross conveyor belt is preferably located in an area inaccessible to the animals. The cross conveyor belt preferably runs along one end of the barn aisles (opposite the egg collection room). Instead of a cross conveyor belt, a pit or a collection container below the scraper or the return device is also conceivable.

It is advantageous if the driver of the manure conveyor device and/or the return device is also located outside the area accessible to the animals. In this case, the conveyor belt is led under a mesh door, for example.

Furthermore, a method for removing manure from a barn according to an example embodiment of the present invention includes providing a manure conveying device including a conveyor that includes a conveyor belt, providing the conveyor belt on at least a portion of a floor area of the barn, collecting manure on the conveyor belt as a standing area for animals kept in the barn, and removing the manure by conveying the manure via the conveyor belt.

The manure conveyor device allows a barn to be laid out lengthwise with the conveyor belt and manure to be collected on the surface of the conveyor belt over a large area and transported away as required.

The conveyor belt preferably has a constant width and has a full-surface design.

The conveyor belt is preferably made at least partly of plastic, in particular PVC, as manure is easy to remove. Alternatively, PU, silicone, PE, or rubber can also be used. The conveyor belt preferably includes at least one fabric layer to increase stability. The transport side is preferably made of plastic. The running side can be coated with plastic to reduce noise. However, it is also conceivable to arrange the fabric layer on the running side, as this is advantageous in damp conditions because no adhesion occurs. The conveyor belt can also be made of polyamide fabric.

The conveyor belt may have a length (in particular continuous) of about 50 m to about 310 m, in particular about 80 m to about 150 m, and/or a width of about 0.5 m to about 30 m, in particular about 0.5 m to about 2 m (e.g., for barn egg production) or about 10 m to about 30 m (e.g., for broiler production), for example. When fully laid out, the conveyor belt covers a large area of the floor space of the barn.

When fully laid out, the conveyor belt is preferably single-layered, which saves material. However, it is also conceivable to design the conveyor belt as a continuous loop.

In addition to use in barns for barn egg production, it is also conceivable to use the system in barns for broiler production. In broiler production, the houses have lengths ranging from about 50 m to about 150 m and a width of the house floor area that is accessible to the animals throughout, ranging from about 10 m to about 30 m, for example. Accordingly, one or more conveyor belts can be used to cover the usable floor area of the house over a large area.

When laid out on the (concrete) floor, the top of the conveyor belt provides a standing area for the animals and can therefore be considered usable floor space. The conveyor belt should be laid out for at least about 80%, and preferably at least about 90%, for example, of the time during the week. When the conveyor belt is laid out, the animals scrape their manure onto it, where it collects. During mucking out, there can be a constant discharge of manure over the entire length of the conveyor belt, which is particularly advantageous for planning removal.

Manure conveyor devices and related methods can be configured or performed as described above.

The above and other elements, features, steps, characteristics and advantages of the present invention will become more apparent from the following detailed description of the example embodiments with reference to the attached drawings.

### BRIEF DESCRIPTION OF THE DRAWINGS

Example embodiments of the present invention are described in more detail below with reference to the drawings. Identical components or components with identical functions have identical reference numerals.

FIG. 1 shows a spatial representation of a manure conveyor device.

FIG. 2 shows a spatial representation of the manure conveyor device of FIG. 1 without showing the driver and the side cover.

FIG. 3 shows a spatial representation of a further manure conveyor device.

FIG. 4 shows a detailed view of the clamped conveyor belt of the manure conveyor device shown in FIG. 3.

FIG. 5 shows a detailed view of the driver of the manure conveyor device shown in FIGS. 3 and 4.

FIG. 6 shows a partial view of another manure conveyor device.

FIG. 7 shows a top view of a portion of the manure conveyor device shown in FIG. 6.

FIG. 8 shows a side view of a barn for barn egg production.

FIG. 9 shows a top view of the barn shown in FIG. 8.

### DETAILED DESCRIPTION OF THE EXAMPLE EMBODIMENTS

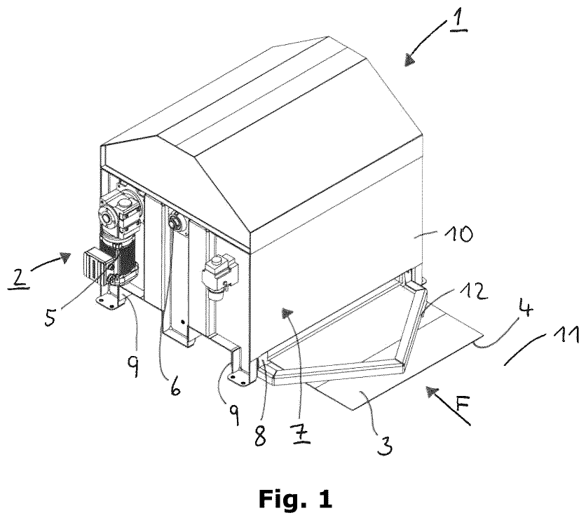

FIG. 1 shows a manure conveyor device 1 with a driver 2 that drives a drive drum (not shown) onto which a conveyor belt 3 is rolled. One end of the conveyor belt 3 is fixed to the drive drum and the other end 4 is free. The driver 2 includes an electric motor 5. The drive drum includes a shaft 6 which is rotatably mounted in a housing 7. The housing 7 encloses the drive drum on all sides and has only one passage 8 for the conveyor belt 3 on the underside. This prevents dirt from entering the housing 7 and damaging the manure conveyor device 1. The underside of the housing 7 also has recesses 9 running transversely to the conveyor direction, which correspond to the openings of standard pallets, in particular Euro pallets, for example, so that the housing 7 and thus the entire manure conveyor device 1 can be easily picked up and transported with a forklift truck or fork lift.

A scraper 12 is attached to the housing 7 on a front side 10, just above the base contact surface 11, which is designed as a V-shaped scraper strip and tapers to a point opposite the winding direction F. The tip is located approximately in the center of the conveyor belt 3.

Barns for barn egg production have parallel or substantially parallel barn aisles between which aviaries are arranged. The barn aisles can be up to about 150 m long, for example.

The manure conveyor device 1 described above is preferably installed at the end of a barn aisle and the conveyor belt is extended and laid in the barn aisle or under the aviaries. The conveyor belt therefore preferably has a length that is at least equal or substantially equal to the length of the barn aisle (freely accessible to the animals), for example.

To pullout the conveyor belt, the driver is in a freewheel mode. The conveyor belt can be pulled out manually or with the aid of an external pulling device that picks up the free end of the conveyor belt and pulls it along the length of the barn. Once the conveyor belt has been pulled out, it covers a large area of the concrete floor on which the hens walk and scratch.

After a specified time or as required when mucking out is necessary, the driver is activated and the conveyor belt is rolled up. The manure on the conveyor belt is pushed against the scraper 12 by the rolling up of the conveyor belt and moves outwards along the V-shaped edge until it falls off the side of the conveyor belt and is scraped off the conveyor belt surface. Below the conveyor belt in the area of the scraper 12, there may be a pit for collecting the manure or a cross conveyor belt that runs across the barn aisles at their end and transports the manure out of the barn into a pit.

It is also conceivable that additional manure is pushed onto the conveyor belt from the uncovered floor area. This can be done manually with a broom, scraper, or other tool, or can be done automatically.

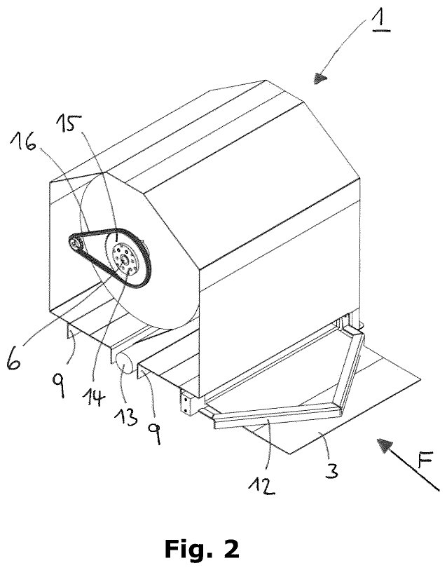

FIG. 2 shows the interior of the manure conveyor device 1. The conveyor belt 3 runs under the scraper 12 and below a return roller 13. The return roller 13 is located under the shaft 6 and is concealed from view when viewed from above. At the return roller 13, the conveyor belt is guided in the opposite direction to the winding direction F towards the drive drum 14 and wound up in the winding direction F by the driver. The return roller 13 can be positioned between the recesses 9 for transport by a forklift truck. A belt pulley 15 is mounted on the shaft 6 and interacts with a belt 16 of a belt driver.

In a further example embodiment not shown, the free end of the conveyor belt is attached to a second drive drum that performs winding in the opposite direction. The second drive drum is assigned a second driver to wind the conveyor belt in the opposite direction. The second driver is designed analogously to the driver described above. The conveyor belt can be moved back and forth in the barn by the two drivers. For this purpose, the conveyor belt is unwound from one drive drum and wound onto the second drive drum and vice versa. Manual or mechanical pulling out with a pulling device is not necessary. If a cross conveyor belt is assigned to both ends of a stable aisle, it is advantageous if a scraper bar or strip is attached to both housings.

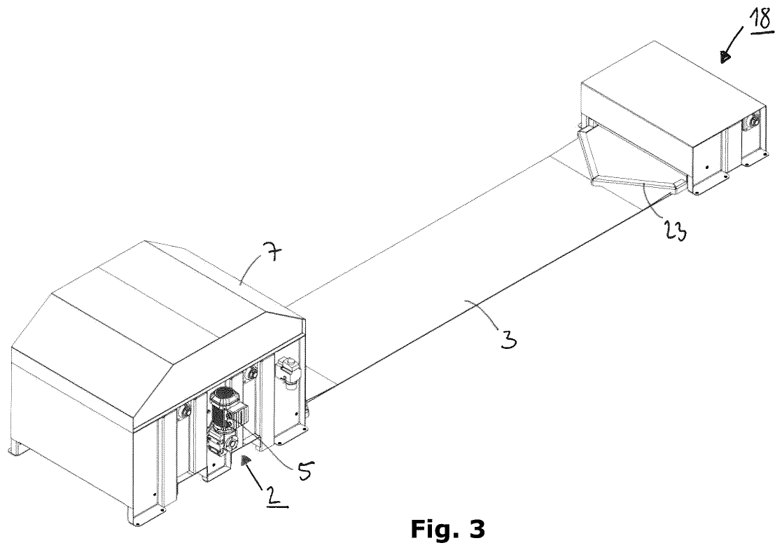

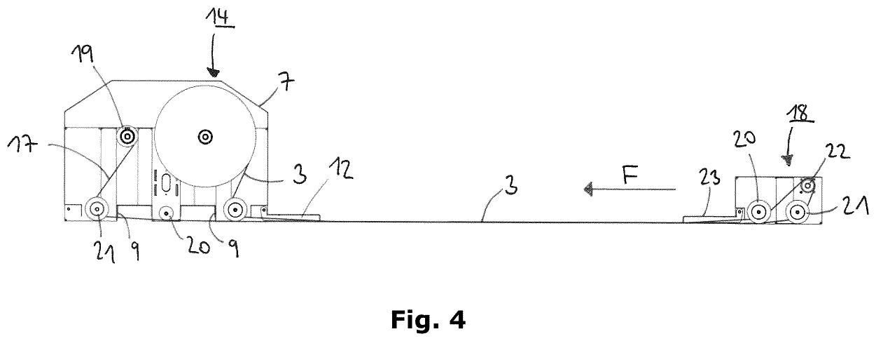

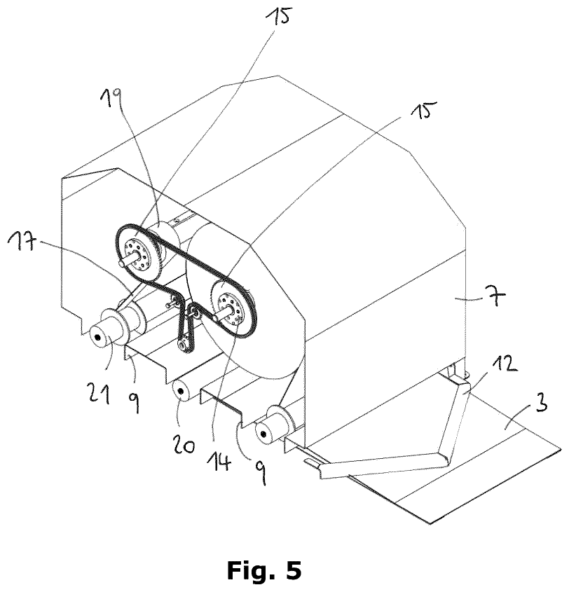

Another example embodiment is shown in FIGS. 3 to 5. A belt 17 is attached to the second end of the conveyor belt 3, which is reversed in direction and returned via a return device 18 and runs below the conveyor belt 3 in the barn. The other end of the belt 17 is wound onto and unwound from a second drive drum 19. However, it is also conceivable that the conveyor belt 3 is returned and designed to be correspondingly longer. The advantage of using a belt 17 is lower wear and lower costs.

The return device 18 includes two guide rollers 20, 21 with lateral guide discs. The conveyor belt 3 or the belt 17 runs below a first guide roller 20 to a return drum 22, which is located above the first guide roller 20 and offset to the rear. From the return drum 22, the conveyor belt 3 or belt 17 runs to the second guide roller 21 and back below this to the driver 2.

When the conveyor belt 3 has been completely unwound from the first drive drum 14, the second end of the conveyor belt 3 is located in the return device 18, preferably in the area of the return drum 22. The belt 17 runs below the conveyor belt 3 and is wound up to a maximum extent on the second drive drum 19. When the conveyor belt 3 is completely rolled up, the back-and-forth belt 17 is located in the barn and the second end of the conveyor belt is located just before the scraper 12 of the housing 7 of the driver 2. The belt 17 is rolled off the second drive drum 19 to the maximum extent. In the housing 7 of the driver 2, the belt 17 is guided by a roller 20 located between the recesses 9 for the forklift fork tines to a guide roller 21, which carries two guide discs that define the position of the belt 17 on the roller 21. From the guide roller 21, the belt 17 runs to the second drive drum 19, to which the end of the belt is firmly connected. The belt or the pulling device and the conveyor belt connected to the belt are collectively referred to as the conveyor.

It is preferable to provide a single electric motor 5 to drive both drive drums 14, 19. The belt 17 of the belt driver engages in a respective belt pulley 15 (tooth wheel) seated on the shaft of the drive drum. The drive drums 14, 19 are assigned a coupling so that the one electric motor 5 rolls the conveyor belt 3 onto the first drive drum 14 and the belt 17 can be rolled off the second drive drum 19 and vice versa. Instead of the belt, another pulling device, such as a rope, chain, or the like, can also be used. It may also be advantageous to use two parallel belts. Belts are the preferred pulling device because wear on the conveyor belt is particularly low during mucking when the pulling device runs below the conveyor belt.

To prevent contamination in the return device 18, a second scraper 23 is provided, which is located in the winding direction F of the conveyor belt 2 in front of the first guide roller 20. The second scraper 23 may be a V-shaped scraper strip and tapers to a point in the direction of winding F, for example. The tip is located approximately in the center of the conveyor belt 3.

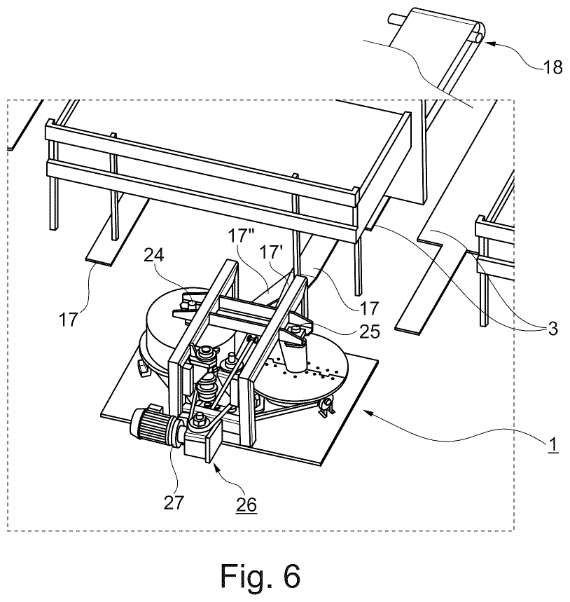

FIG. 6 shows a further example embodiment of a manure conveyor device 1. A belt 17 is attached to each end of the conveyor belt 3 as a pulling device. The two belts 17 can be wound onto and unwound from a drive drum 24, 25. The two drive drums 24, 25 are driven by a single driver 26. A coupling enables one electric motor 27 to roll a first belt 17′ onto a first drive drum 25, while the second belt 17″ can be rolled off the second drive drum 24, and vice versa. To ensure that the driver is as compact as possible, the belts 17 are positioned by guide rollers and wound upright (not shown). FIG. 6 does show the positioning of the belt schematically. The axis of rotation of the drive drums 24, 25 is aligned vertically. The conveyor belt 3 or the belt 17 runs around a purely schematically represented return device 18. The conveyor belt 3 is dimensioned such that it covers a portion of the floor area over the length of the barn aisle. In FIG. 6, the conveyor belt 3 is located below the aviary. Two further conveyors with conveyor belts 3 and belts 17 are shown, but these are part of other manure conveyor devices that are not shown.

To enable the conveyor belt 3 to run almost completely around the return device 18 during mucking out, the two belts 17 are of corresponding length. Mucking out can be carried out by a scraper, as described above, arranged in front of a drive assembly, from where the manure falls into a pit onto a cross conveyor belt (not shown). However, it is also conceivable to provide a scraper on the upper side and to locate the return device in front of (or slightly above) a pit and/or a cross conveyor belt so that when the conveyor belt runs around, the manure falls from the upper side onto the cross conveyor belt. A scraper can be provided in the area of the return drum to prevent manure from remaining on the transport side of the conveyor belt and being pulled through the barn with the conveyor belt. During mucking out, the conveyor belt is partially doubled and the transport side (top side) is partially facing the floor of the barn. After mucking out, when the conveyor belt has completed at least a large portion of its run around the return device 18, preferably completely, the conveyor belt is laid out in the opposite direction into the barn with the transport side facing upwards. Preferably, the length of the conveyor belt is less than the distance between the driver 26 with the drive drums 24, 25 and the return device 18.

All example embodiments have in common that the upper side of the conveyor belt provides a contact or floor surface for the animals or is available as usable stable floor space. In other words, the conveyor belt lies on the concrete floor of the stable and the animals stand directly on the conveyor belt. The conveyor belt covers a large area of the floor contact surface for at least about 90%, preferably about 95%, for example, of the time in a week. For mucking out, the conveyor belt is moved, causing the upper side of the conveyor belt to come into contact with the lower side of the conveyor belt in some areas, and the conveyor belt is rubbed together over a large area. When fully laid out, the conveyor belt is preferably single layer (i.e., not a double layer). Mucking out is preferably carried out with a continuous, preferably essentially constant discharge of manure onto a cross conveyor belt.

The conveyor belt 3 of the manure conveyor device is preferably a PVC conveyor belt. Alternatively, the conveyor belt can also be made of PU, silicone, PE, or rubber. The conveyor belt preferably includes at least one fabric layer. The fabric layer can be arranged on the running side. However, it is also possible for the underside to be coated with plastic. Poultry manure adheres poorly to such plastic conveyor belts and is particularly easy to wipe off.

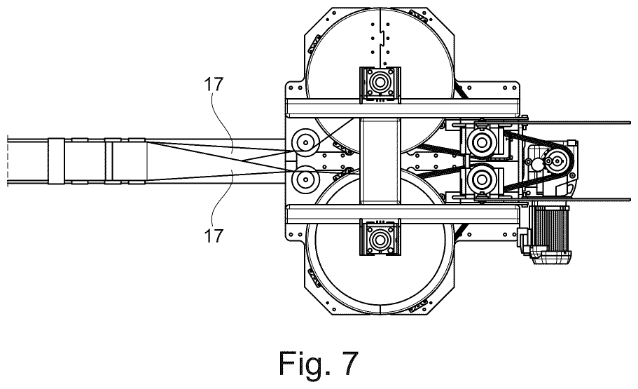

FIG. 7 shows the uprighting of the belts 17. In the example embodiment shown, the two counter-rotating belts 17 lie (directly) on top of each other and are positioned for rolling up and down. Uprighting the belts makes it possible to keep the device particularly compact.

It is also conceivable to provide two pulling devices per conveyor belt end and to arrange these on the side of the conveyor belt so that the conveyor belt does not have to run over or under the pulling devices, and these always lie on the side at a distance from the conveyor belt. Such an arrangement can be used in general for the above example embodiments, as this keeps wear on the conveyor belt to a minimum.

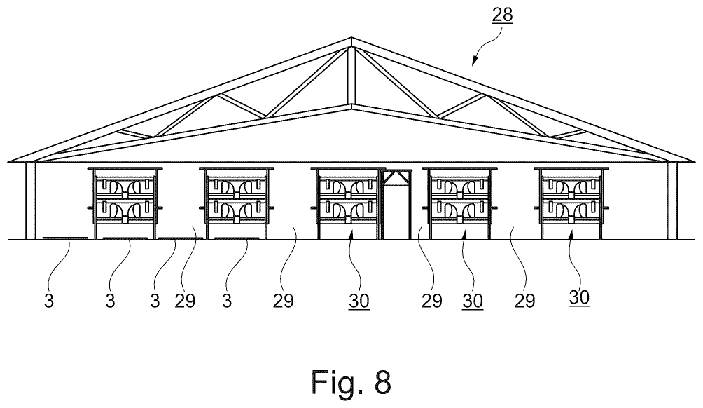

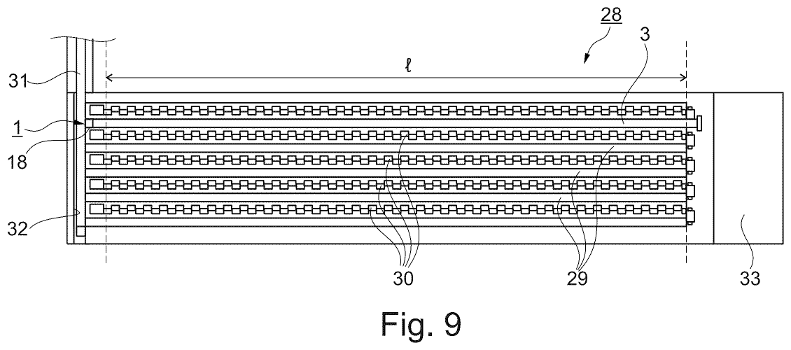

FIGS. 8 and 9 show a barn 28 for barn egg production. The barn 28 includes parallel barn aisles 29 between which aviaries 30 with laying nests (not shown) are arranged. The aviaries are elevated and have several levels. The concrete floor area of the barn or the usable floor space for the hens is thus located below the aviaries and in the barn aisles and is available as a scratch area for the laying hens. The conveyor belt 3 of a manure conveyor device can be laid out in a barn aisle 29 and/or below the aviaries 30. FIG. 9 shows an example of the arrangement in a barn aisle. Preferably, each barn aisle and/or each area below the aviaries is equipped with a conveyor belt. When fully laid out, the conveyor belt 3 preferably extends over the entire length 1 of the barn aisle, in particular over at least about 90% of the barn aisle length, for example. The barn aisle length is illustrated in FIG. 9 and is defined by the length of the usable barn floor space accessible to the animals.

The barn aisles 29 are assigned a cross conveyor belt 31 at one end, which runs transversely to the barn and can be located in a pit 32 (see FIG. 9). An egg collection room 33 is assigned to the other end of the barn aisles. The cross conveyor belt 31 runs from the inside of the barn to the outside and thus transports the manure out of the barn.

The cross conveyor belt 31 also picks up the manure from the manure removal devices, which are arranged in the aviaries below the grids and are designed to run around continuously (not shown).

The drive assembly of the manure conveyor device 1 can be arranged on the side of the cross conveyor belt or the pit, as explained above, and may include a scraper. In this case, the drive assembly is located on the side of the pit facing away from the aviaries. In other words, the conveyor belt runs over the pit (not shown). However, it is also conceivable that, if a return device 18 is used, this is located at the end of the barn with the cross conveyor belt 31. Since the manure falls off the conveyor belt 3 during return, the return device is located on the side of the pit or cross conveyor belt closest to the aviaries and may partially protrude above the pit. The drive assembly is located at the end of the barn aisle near the egg collection room.

As shown in FIG. 9, both the return device and the drive assembly including the driver and drive drums are located outside the usable floor space of the barn and are not accessible to the animals.

The manure conveyor devices and methods according to example embodiments are also suitable for mucking out barns for broiler production that are laid out over a large area by at least one conveyor belt.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A manure conveyor device comprising:
a conveyor including a conveyor belt to receive manure; and
at least one driver to move the conveyor; wherein
a first end of the conveyor is fixedly connected to a first rotatably drivable drive drum;
the manure conveyor device is configured to remove manure located on the conveyor belt when the conveyor is wound onto the first rotatably drivable drive drum.

2. The manure conveyor device according to claim 1, wherein the conveyor belt is at least partially made of plastic.

3. The manure conveyor device according to claim 1, wherein the conveyor belt has at least one of a length of about 50 m to about 310 m or a width of about 0.5 m to about 3.5 m.

4. The manure conveyor device according to claim 1, wherein
a second end of the conveyor is fixedly connected to a second rotatably drivable drive drum;
the manure conveyor device further comprises a return device around which the conveyor reverses direction and returns.

5. The manure conveyor device according to claim 4, further comprising a single driver to selectively drive the first rotatably drivable drive drum or the second rotatably drivable drive drum.

6. The manure conveyor device according to claim 1, wherein at least one end of the conveyor belt is connected to a pulling device connected to the first rotatably drivable drive drum.

7. The manure conveyor device according to claim 4, wherein the first and second rotatably drivable drive drums are in a vicinity of each other and a distance to the return device is in a range between about 50 m and about 310 m.

8. A method of using the manure conveyor device according to claim 1 for at least partially covering a floor area for animal husbandry with the conveyor belt and removing manure from the floor area via the conveyor belt.

9. The method according to claim 8, wherein the floor area is located in a barn for barn egg production and the conveyor belt provides a usable floor area for laying hens.

10. A barn for barn egg production, the barn comprising:
parallel or substantially parallel barn aisles and aviaries arranged therebetween;
a floor area to provide a scratching area for laying hens; and
at least one of the manure conveyor device according to claim 1.

11. The barn according to claim 10, further comprising a cross conveyor belt running transverse to the barn aisles and the at least one manure conveyor device which, when fully extended, covers a portion of the floor area with the conveyor belt and is configured to remove manure from the conveyor belt to a transport side of the cross conveyor belt.

12. A method for removing manure from a barn, the method comprising:
providing a manure conveyor device including a conveyor that includes a conveyor belt;
providing the conveyor belt on at least a portion of a floor area of the barn;
collecting manure on the conveyor belt as a standing area for animals kept in the barn; and
removing the manure by conveying the manure via the conveyor belt.
